(19) United States
(12) Patent Application Publication
(10) Pub. No.: US 2014/0061420 A1
(43) Pub. Date: Mar. 6, 2014

(54) Slit Diaphragm Flexure

(71) Applicant: National Security Technologies, LLC, Las Vegas, NV (US)

(72) Inventors: Morris Kaufman, Los Alamos, NM (US); Brian Cox, Los Alamos, NM (US)

(73) Assignee: National Security Technologies, LLC, Las Vegas, NV (US)

(21) Appl. No.: 13/968,418

(22) Filed: Aug. 15, 2013

Related U.S. Application Data
(60) Provisional application No. 61/691,232, filed on Aug. 20, 2012.

(51) Int. Cl. G02B 7/182

(52) U.S. Cl. CPC G02B 7/182
USPC 248/469; 248/122.1; 428/596

(57) ABSTRACT

A gimbal is disclosed having a base with a bottom and a support structure extending up from the bottom. Two or more mounts connected to the base and a stiffener connects to two or more mounts. A slit diaphragm flexure connects to the stiffener around at least an outer circumference of the slit diaphragm flexure and one or more adjustors are provided to move the flexure. The stiffener may be two separate elements which releasably connect and secure the outer area of the flexure there between. The adjustors are configured to move upward or downward and contact the slit diaphragm flexure to thereby move the slit diaphragm flexure in response to movement of the adjustor. The flexure includes two or more slits that allow movement of a center area relative to an outer ring. The slit includes relieved areas that provide stress relief and increase orthogonal of movement.

### 2. PRIORITY CLAIM

This application claims priority to and the benefit of U.S. Provisional Patent Application No. 61/691,232 filed on Mar. 15, 2013 titled Slit Diaphragm Flexure.

### 1. STATEMENT REGARDING FEDERAL RIGHTS

This invention was made with government support under Contract No. DE-AC52-06NA25946 and was awarded by the U.S. Department of Energy, National Nuclear Security Administration. The government has certain rights in the invention.

### 3. FIELD OF THE INVENTION

The invention relates to gimbals and in particular to a flexure and optional stiffener for use with a gimbal or other positioning system.

### 4. RELATED ART

For precise optical signal manipulation it is required to have very precise control over the adjustment angle of an optic device, such as for example of mirror or other optic element. To achieve such precise control the optic element is connected to or otherwise linked to a support and adjustment mechanism such that the adjustment mechanism is accurately configured to control any aspect of the optic element position.

The preferred position controllers (such as for controlling a mirror position) have reduced weight, zero backlash, low friction and lubrication, motion smoothness, and virtually infinite resolution, along with compact size and low weight and ease of manufacture. Applications for position controllers include accelerometers, gyroscopes, translation micro-positioning stages, motion guides, piezoelectric actuators and motors, high-accuracy alignment devices for optical fibers, missile-control devices, displacement amplifiers, scanning tunneling microscopes, high-precision cameras, robotic micro-displacement mechanisms, orthotic prostheses, antennas and valves.

Prior art mirror position controllers include hinge flexures, compound flexures, rotary flexures, disk flexures, and bearings. However, these type elements suffer from numerous drawbacks. For example, certain prior art flexures are undesirably large while other flexures, such as hinge flexures, only provide adjustment along one axis. Other flexure or bearing system suffer from having inadequate range of motion or are not sufficiently sensitive to small adjustments. The flexure described herein overcomes the drawbacks of the prior art and provides additional benefits as disclosed below.

### SUMMARY

To overcome the drawbacks of the prior art and provide additional benefit, ab gimbal is disclosed comprising a base having a bottom and a support structure extending up from the bottom. Two or more mounts connected to the base and a stiffener connects to two or more mounts. A slit diaphragm flexure connects to the stiffener around at least an outer circumference of the slit diaphragm flexure and one or more adjustors are provided. The adjustors are configured to contact the slit diaphragm flexure and move the slit diaphragm flexure in response to movement of the adjustor.

In this embodiment the stiffener may comprise a first ring and a second ring which are releasable secured together by two or more fasteners. And, the slit diaphragm flexure may connect to the stiffener by being secured between the first ring and the second ring. Also part of this embodiment may be at least one adjustor associated with each axis of motion.

The slit diaphragm flexure may comprise a sheet of metal having one or more slits around an outer circumference and one or more bridges between the slits. In one configuration the slit diaphragm flexure comprises a sheet of titanium having one or more generally open slits and one or more bridges. The bottom of the base may be is configured with one or more connection points to connect the base to a table or other support surface. This embodiment may further comprise a mirror connected to an outer surface of slit diaphragm flexure.

Disclosed herein is a flexure and stiffening element system for use in a gimbal comprising a generally planar sheet of metal, the sheet having an outer edge section, a middle section, and an intermediate region between the outer edge section and the middle section, the intermediate region having one or more slits and one or more bridges.

Each of the one or more slits may comprise a narrow opening in the sheet running generally parallel with the outer edge. In one embodiment the one or more bridges comprise a solid section of sheet between the one or more slits that connects the middle section to the outer edge section. The stiffening element may have a shape that matches the outer edge section. In one configuration the stiffening element comprises a first element and a second element configured to releasably connect to thereby secure the outer edge section between the first element and a second element such that both the first element and the second element have a shape that matches the outer edge section.

Also disclosed herein is a movable mirror support that comprises a base having a bottom section and a top section and a stiffening element configured to hold a sheet flexure. Also part of this embodiment is a mount configured to connect the stiffening element to the base. A sheet flexure held by the stiffening element, the sheet flexure formed from a flexible sheet of material contained primarily within the stiffening element and configured as having three parts. First, an outer section held by the stiffening element, second, an inner section configured to connect to and support the mirror, and third, a flexure section between the outer section and the inner section, the flexure section comprising two or more slits and two or more bridges. One or more adjustors are also provided and configured to move relative to the base to thereby contact the inner section to move inner section relative to the base.

In one embodiment the top section is angled to present the mirror at an angled position. The two or more slits comprise openings cut from the sheet flexure and the two or more bridges comprise sections of sheet between the openings which connect the outer section to the inner section. In one embodiment the stiffening element comprises at least one rigid structure having a shape that generally matches the outer section of the sheet flexure but not extending into the inner section of the sheet flexure. In one configuration moving the inner section relative to the base comprises moving the angle of the inner section. The flexure may comprise one or more threaded screw adjustors which move upward or downward when rotated. In one embodiment the support further comprises a mirror connected to the inner section of the sheet flexure.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an example environment of use.

FIG. 2 illustrates an exemplary gimbal base and mounts.

FIG. 3 illustrates exemplary adjustors associated with a flexure.

FIG. 4 illustrates an exemplary slit diaphragm flexure with stiffening element.

FIGS. 5A, 5B, 5C illustrate an exemplary slit diaphragm flexure showing axial displacement and angular displacement capability.

FIG. 6 illustrates an alternative configuration of a slit diaphragm flexure with stiffening element.

FIG. 7 illustrates an exemplary flexure performance without a stiffening element including center of rotation based on finite element analysis.

FIG. 8 illustrates an exemplary flexure performance with a stiffening element including center of rotation based on finite element analysis.

FIG. 9 illustrates an exemplary of the flexure showing relieved sections near a flexure bridge.

FIG. 10 illustrates an exemplary flexure under flexing rotational force with an enlarged view of the bridge showing numeric flex values.

### DETAILED DESCRIPTION

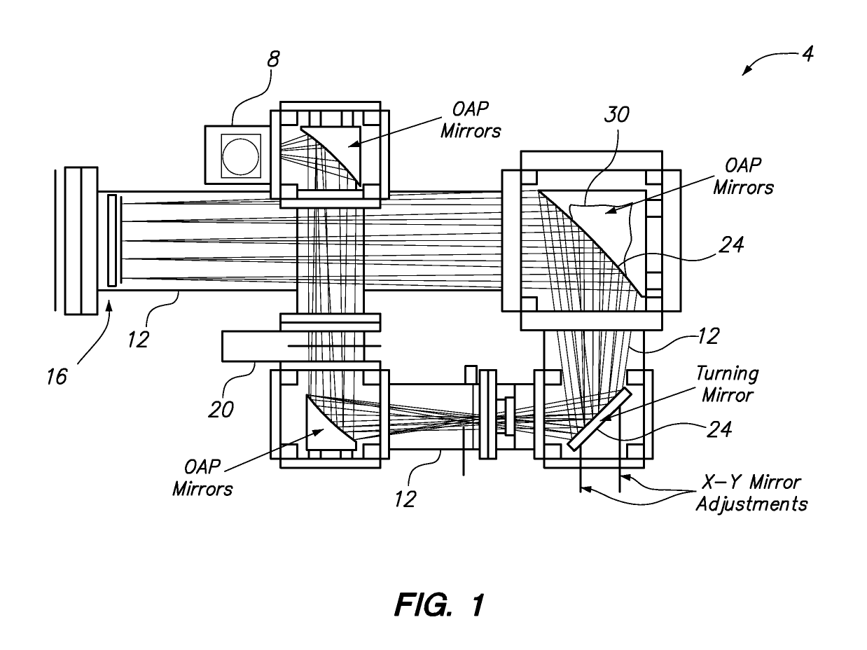

FIG. 1 illustrates an example environment of use which includes an optical environment 4 including a light source 8 which generates or presents a light signal to one or more optic paths 12. The destination of the optic signal is an optic signal destination 16 which may comprise any element configured to receive a light signal. In addition, one or more intermediate optic devices 20 may be placed at any location within the optic paths 112 to monitor or modify the light signal.

To precisely control the path of the light signal, one or more mirrors 24 are provided as shown in FIG. 1. In this embodiment the mirrors are OAP (off axis parabolic) mirrors. Precise position control of these mirrors is essential to establish the desired optic signal path. To control the position of these mirrors, one or more mirror position controllers 30 are provided in connection to the mirror. Through adjustment of the position controllers, the position of the mirror 24 may be accurately adjusted and maintained.

Although shown in this example environment, it is contemplated that the innovation described below may be enabled in any environment which would benefit from precise position control and position maintenance of an element, including non-optic elements.

There are five main parts to the gimbal and associated elements as shown in the attached figures. These main parts include a gimbal base, one or more mounts, adjustors, which adjust the position of a flexure, a slit diaphragm flexure, and a stiffening structure which stiffens the flexure. Each of these elements is discussed below.

Although the discussion below is directed to use of a mirror, it is contemplated that any element may be mounted on or configured as part of the gimbal. In other embodiment the mirror 106 may be replaced with a light source, sensor, emitter, detector, or any other element for which precision adjustment is required.

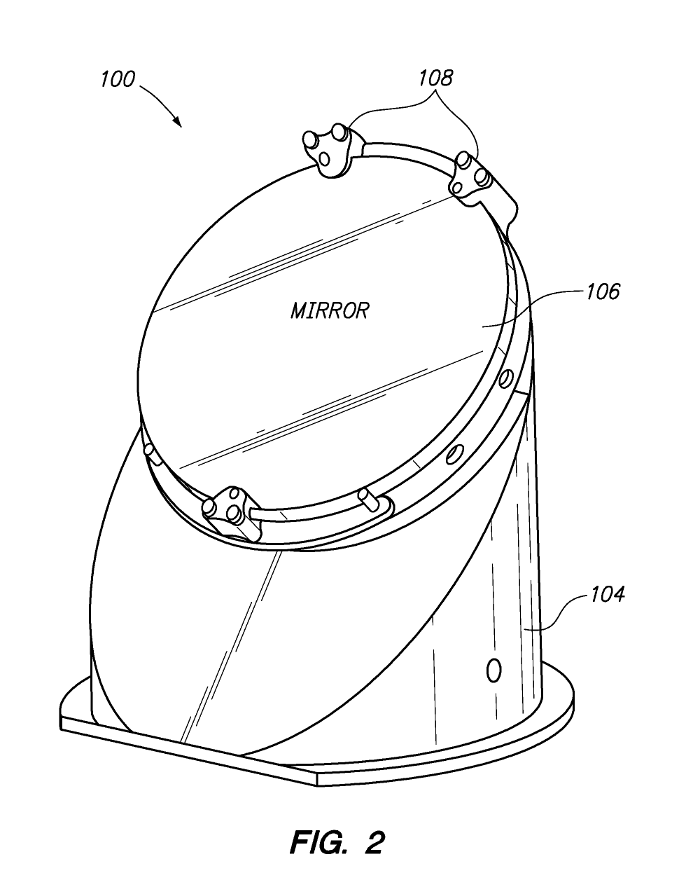

FIG. 2 illustrates an exemplary gimbal base 104 and mounts 108 that are part of a gimbal 100. As shown, a base 104 is configured to support the mirror 106. The base 104 also connects to support surface (not shown), such as a table or other solid structure. Also shown in FIG. 2 are gimbal mounts 108 which connect to the base 104 and one or more of the mirror 106, stiffener, or flexure. The stiffener and flexure are not shown in FIG. 2 but are located behind the mirror 106.

The base 104 may be made of any generally ridged material such as for example metal, plastic, resin or glass. The base 104 may be configured in any shape such as would be suitable to connect to a table or other solid structure and fit within the space allotted for the gimbal including the base. It is contemplated that the base 104 may be shaped to angle or direct the mirror at a predetermined angle as would depend on the particular use of the gimbal. For example, as shown in FIG. 2, the mirror 106 is angle at about a 45 degree angle in relation to the horizontal bottom surface of the base 104. Mounting of the mirror may be achieved using any connection system known such as clamps, adhesive, glue, PTFE-impregnated glass tape on the mirror 106 may have a frame mounting surface to which such connections may be made. In addition, the mirror may be preload using any biasing system including use of spring plungers above the pads around the mirror's perimeter, which are generally discussed below.

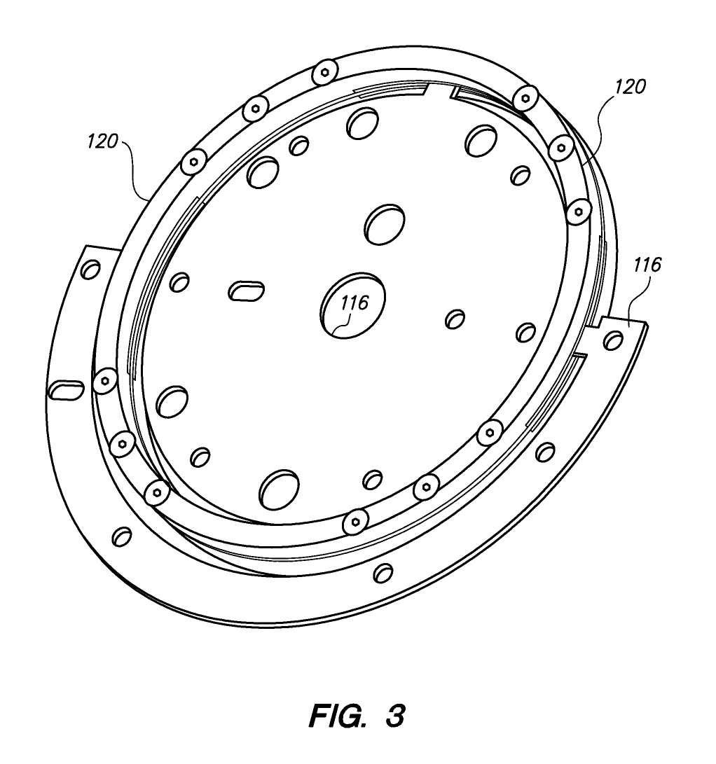

FIG. 3 illustrates an exemplary slit diaphragm flexure with stiffening element. In this exemplary embodiment the flexure 116 comprises a thin sheet of metal with sections cut and removed from the sheet to allow flexure of the metal sheet. The cut outs, which may be referred to as slits, may allow for flexing along one axes, two axes, or three axes. One or more bridges (not shown in FIG. 3) are between the slits and are area of the sheet which are not removed. As a result of the slits, the flexure 116 can accommodate a combination of angular and axial displacements. Because it is made from a thin sheet of metal, this type of flexure 116 is simple to machine with modern machining processes such as electro-discharge machining, water jet cutting, or laser cutting.

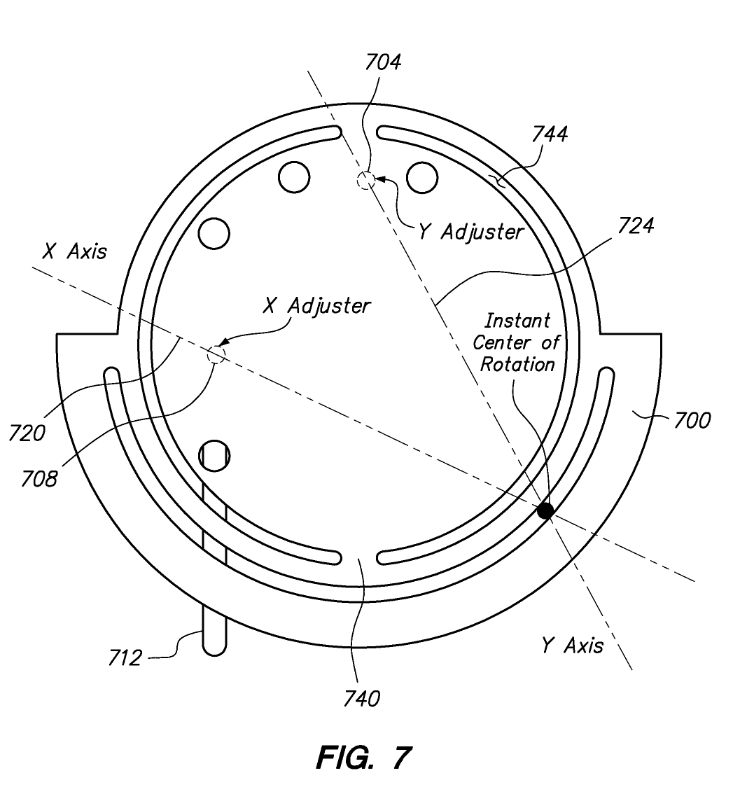

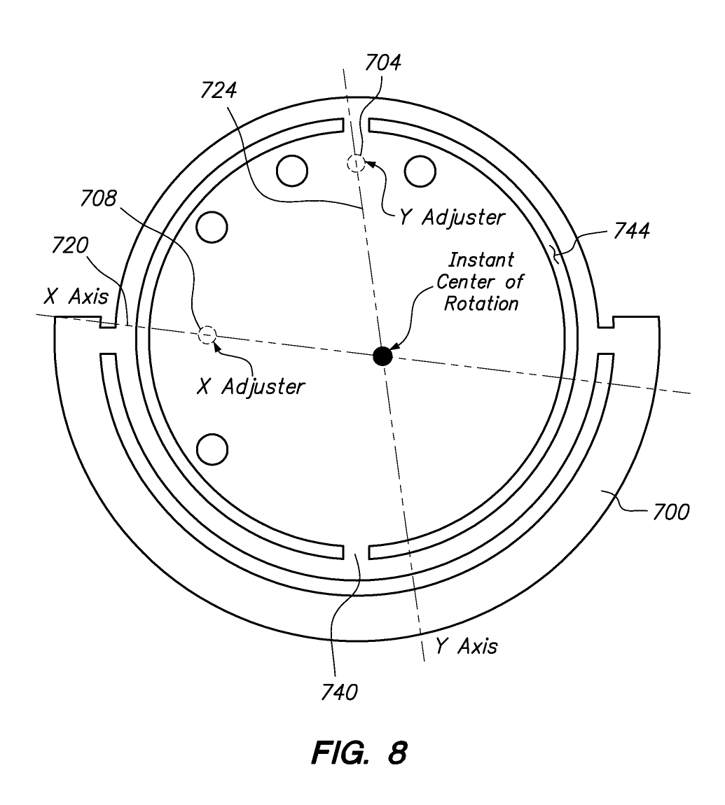

In this embodiment the flexure is a slit diaphragm flexure. Slit diaphragm flexures is utilized in this application because stiffness in radial directions is preferred but axial and angular position is constrained by other components. When used directly in a two-axis gimbal application where angular displacements about specific axes are preferred and axial displacements are to be avoided. As a result, special attention must be given to adjustment mechanism placement and flexure stiffening to reduce coupling of the X and Y adjustments and provide orthogonal axes of rotation. This is discussed below in greater detail in connection with FIGS. 7 and 8.

In this example embodiment the flexure is electro-discharge-machined out of a 0.032″ thick sheet of titanium 6A1-4V. In other embodiments the flexure may be made out of other materials or elements, or a combination of materials or alloys. Likewise, the flexure may be established at other thicknesses and such thicknesses may be uniform across the flexure or variable. In this embodiment the high-strength titanium alloy 6A1-4V has a high tensile yield strength and low modulus of elasticity, allowing for large deformation in the linear elastic region of the flexure.

The flexures disclosed herein have the additional feature of one or more stiffening elements 120 in order to provide specific preferred regions of deformation while reducing or eliminating deformation in other areas. These stiffeners 120 provide enhanced performance by providing nearly perpendicular adjustment axes and a center of rotation near the center of the gimbal. As an advantage over prior art designs both of these features achieve a lower profile and simpler design than conventional gimbals.

As shown in FIG. 3, the flexure 116 is thus supported on its outer edge by a stiffener 120. In this embodiment, the stiffener 120 comprises two stiffeners matched to the outer edge of the flexure 116. The stiffeners 120 clamp together on both sides of the flexure 116 with twelve screws 124 securing the outer edge. In other embodiment other shapes and connection means for the stiffeners 120 may be enabled, such as glue, adhesive, or any other connection means.

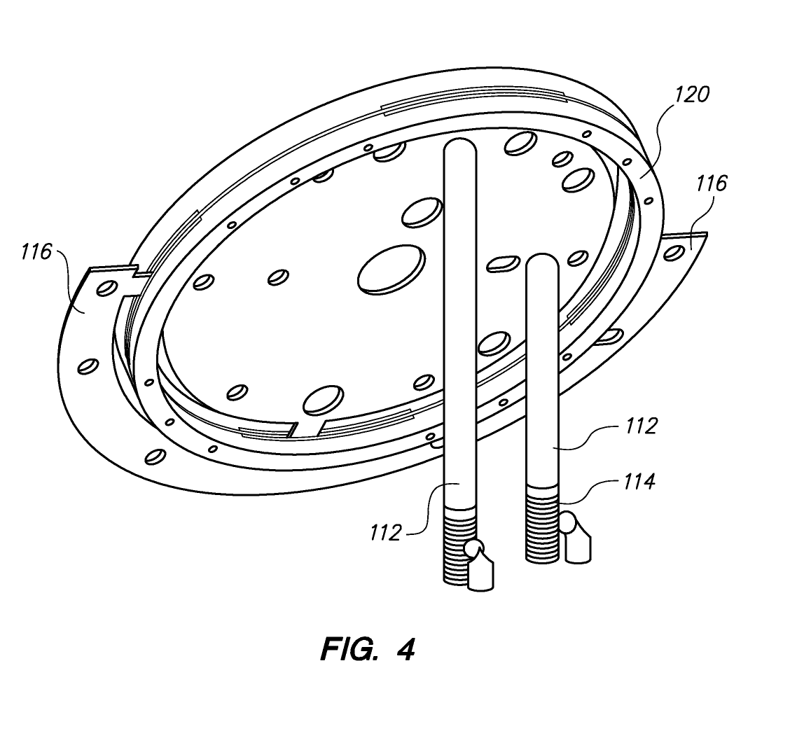

FIG. 4 illustrates exemplary adjustors associated with a flexure. In this embodiment one or more adjustors 112 are in contact with the back side of the inner part of the flexure. In this configuration the adjustors 112 are shown below and behind the flexure 116 and are configured to apply pressure to the flexure which in turn moves the flexure.

The adjustors 112 translate input from a user or machine to movement of the flexure 116 (which in turn moves the mirror). The adjustors 112 may comprise any type adjustment mechanism. The adjustors 112 accept movement input from the user, such as through turning of a screw or from a stepper motor, which in turn physically pushes on the flexure 116 upward or downward, which in turn moves the flexure and the associated mirror attached thereto.

In one example embodiment, the angular adjustment about the X axis and Y axis is achieved with two spherical-tip pushers 112, as shown. The depth of the pushers 112 may be is set with setscrews, and each adjustment may include a non-influencing locking mechanism. Preload may be is maintained on each of the pushers with a pair of extension springs or other biasing device. In one embodiment, the X adjustment is located 1.125″ from the center of the flexure, and the Y adjustment is located 1.325″ from the center of the flexure. Estimating that a skilled technician using a hex wrench has at least 1° of sensitivity in adjustment, this equates to a sensitivity of 3.5 μm using a ¼-28 setscrew. With this adjustment sensitivity, the gimbal thus achieves an angular sensitivity of 0.12 mrad about the X axis, and 0.11 mrad about the Y axis. In other embodiment, using other locations for the adjustors in relation to the flexure and other adjustment configurations, different resolutions may be achieved.

In other embodiment any type of device or system may be utilized as the adjustors 112. In addition, any number of adjustors 112 may be utilized to provide the adjustment. For example, if motion along a single axis is desired then a single adjustor 112 may be included while a greater number of axis of adjustment may be achieved with two or more adjustors. In one embodiment, the adjustors are linked, either mechanically or via electrical or magnetic controllers to operate in unison or individually to achieve motion control over the mirror. Although shown as threaded 114 or screw type adjustor, it is contemplated that any type mechanism may be utilized to effect upward and downward movement of the adjustors 112. In addition, it is contemplated that the adjustors 112 may be placed at different angles relative to the flexure 116.

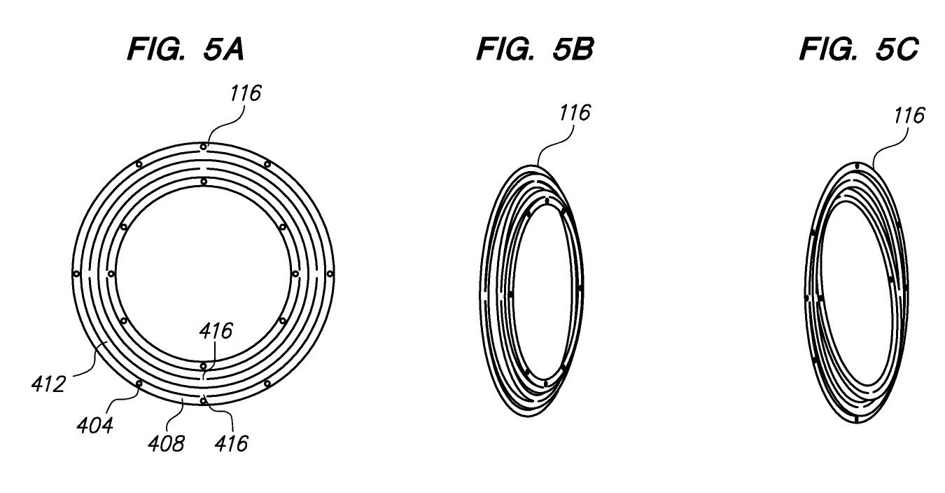

FIGS. 5A, 5B, 5C illustrate an exemplary slit diaphragm flexure including performance capability in for axial displacement and angular displacement. This type of flexure is valuable for its design and ability to provide radial support while providing a wide range of motion. As shown in FIG. 5A, the flexure may have any arrangement of slits 408 and bridges 416 within a generally planer solid sections 412. In this embodiment one or more radial concenter slits 408 cut into the sections 412 but in other embodiment patterns other than radial arcs may be established.

One or more bridges 416 interconnect the solid sections 412 and interrupt the slits 408. The location of the bridges 416 and slits 408 are selected based on the angular displacement that is desired and the location of the adjustors in relation to the location of the bridges and slits. As can be appreciated, the flexure will flex along the slits 418 and resist flexure or movement where solid bridges 416 remain connected.

In this embodiment, the center is void of any material but in other embodiments one or more sections of sheet or other matter may remain in the center. As can be appreciated by one of ordinary skill in the art, this is but one possible configuration and other configuration may also be enabled. When compared to other solutions such as blade flexures or bearings, a slit diaphragm flexure has advantages such as large displacement, simplified assembly, reduced design complexity, and excellent sensitivity.

FIG. 5B illustrates the axial deflection of the flexure extending from the plane of the outermost ring. This provides the benefit of being able to adjust the location of the mirror, or other element, along an axis that is non radial or which is aligned with an axis that perpendicularly intersects the plane of the generally flat flexure surface. FIG. 5C illustrates angular deflections of the flexure. As can be appreciated from FIGS. 5B and 5C, the flexure enjoys a range of motion enabled by the slits 408 and constrained by the bridges 416. By adjusting the location and width of the bridges 416 and slits 408, in connection with the adjustors, the degree of deflection is controlled while maintaining support for the mirror or other element.

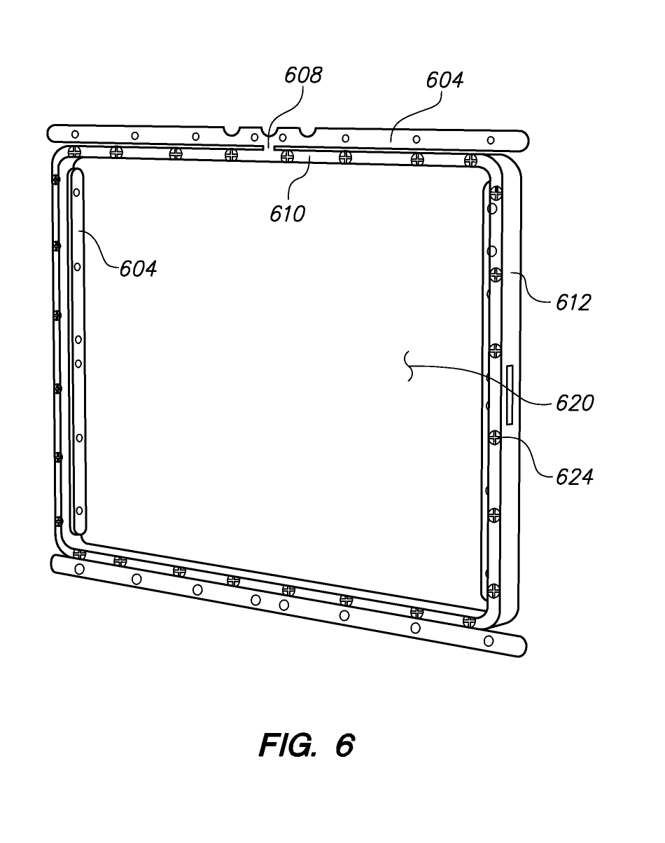

FIG. 6 illustrates an alternative configuration of a slit diaphragm flexure with stiffening element. This configuration is generally similar to the flexure and stiffener shown in FIG. 3 but is arranged in a generally rectangular configuration. As shown a generally planar and ridged sections 604 is configured from a sheet of metal or other generally planer and ridged material. Cut from the section of planar material are one or more slits 610 which provide an opening between the solid sections 604. Linking an inner and outer solid section is a bridge 608. In this embodiment the bridge 608 is formed by not removing a portion of the solid section 604.

In this configuration the flexure is formed as a rectangle having an opposing top and bottom and two opposing sides which together connect at the ends to form a rectangle. A slit 610 runs the length of each side forming two parallel solid sections which are separate by the slit. A bridge 608 is located at the center of slit and the bridge interrupts the linear slit to connect the solid sections as shown. The center area 620 is generally open as shown but in other embodiments may be solid.

A stiffener 612 is provide around the outer edge of the solid sections 604 t provide support as described herein. The stiffener 612 may be established as having a front section and a back section between which the solid section 604 is secured. Multiple connectors 624, such as screws or bolts, may secure the front section to the back section. In one embodiment the stiffener 612 comprises a single element and the flexure mounts directly to the stiffener.

Using adjustors (not shown in FIG. 6), which contact the solid surface 604, the position and angle, relative to the plane of the stiffener 624, of the solid surface may be adjusted. The adjustors may comprise any type adjustor as discussed herein capable of moving the solid surface, regardless of whether the solid surface is as shown or a solid inner section.

The flexure shown in FIG. 6 allows the overall gimbal profile to be kept low while still maintaining the necessary degrees of sensitivity and adjustment range. In one configuration, the gimbal design has an overall thickness of 1.75″ not including the micrometer adjusters and further achieves orthogonal X and Y adjustment axes. Moreover, it also provides a center of rotation centered about the gimbal.

In one configuration angular adjustment about the X and Y axes is achieved with a pair of Newport DM-L series differential micrometers, which have a sensitivity of 0.1 μm and a non-influencing lock. Preload is maintained on each micrometer with a pair of extension springs around each adjuster for both positive and negative adjustment. The X adjustment micrometer is located 5.38″ from the center of the mirror and the Y adjustment micrometer is located 4.63″ from the center of the mirror. With the 0.1 μm sensitivity of the micrometers, the gimbal achieves an angular sensitivity of 0.73 μrad in X adjustment and 0.85 μrad in Y adjustment.

The micrometers have a total travel range of 13.0 mm, which results in a total angular adjustment range of ±2.7° in X adjustment, and ±3.2° in Y adjustment. Hardened carbide pads may be provided under each micrometer head to ensured that the contact surfaces would not dimple under compression which would compromise the angular sensitivity of the gimbal. A thin layer of damping grease may be applied to the carbide pad to prevent frictional jumping or sticking at the micrometer/pad interface during adjustment. The flexure-based design provided excellent sensitivity for back-reflection alignments over a long lever arm. In this embodiment, the angular sensitivity of the gimbal provides a beam positioning sensitivity of 24 μm at a distance of 30 m. The flexure shown in FIG. 6 may utilize the same basic components as the gimbal shown in FIGS. 3 and 4 including the slit diaphragm flexure and two stiffeners that clamp both sides of the flexure. The flexure may be electro-discharge-machined out of a 0.032″ thick sheet of titanium 6A1-4V, providing large adjustment range and low required force on the micrometers.

FIG. 7 illustrates an exemplary flexure without a stiffening element including center of rotation based on finite element analysis. The flexure 700 is shown as a basic design having two or more bridges 740 spanning the circular slits 744. In this figure, the Y axis adjustor is at position 704 while the X axis adjustor is at position 708. The X axis adjustor 712 is partially visible. The X axis 720 defines the axis along which the flexure moves in response to adjustment of the X axis adjustor 712. The Y axis 724 defines the axis along which the flexure moves in response to adjustment of the Y axis adjustor.

In operation movement of the adjustors presents pressure on the inner section of the flexure 700 at the adjustor location 704, 708, which in turn flexes the flexure along the slits. The bridges 740 resist movement. Movement of the X axis adjustor 712 causes the flexure 700 to move along the X axis. Movement of the X axis adjustor 712 causes the flexure 700 to move along the X axis. However, as discussed below, movement of one adjustor individually, may generate movement along both axis, which is typically unwanted.

For example, one of the design challenges presented when building the gimbal with slit flexure is non-orthogonality, which may also be referred to as coupling, of alignment axes when only a single pusher for each axis is used. One of the more basic slit diaphragm flexure that was designed, as seen in FIG. 7, is essentially a set of four curved beams supporting an inner plate. It can be shown that the stiffness and stress in such a flexure can be calculated in these individual beams for certain load cases, but these loading conditions make the assumption that moments and forces are evenly distributed between the beams. In the case of a slit diaphragm flexure, which is loaded irregularly, more advanced modeling was performed.

Modeling the slit diaphragm flexure in ANSYS was used to accurately predict adjustment capabilities of the gimbal for various designs. ANSYS is a mathematical modeling software available from ANSYS Inc. located in Canonsburg, Pa. For the ANSYS model the outer ring of the diaphragm flexure was constrained with a fixed condition, and the spherical-tipped adjusters were modeled with a frictionless contact condition on the back side of the flexure. The inner ring of the flexure was stiffened by the mirror mounting plate, and spring forces were applied to the mirror plate corresponding to preload springs in the design. By moving each adjustment individually, deflection and stress results were calculated for the purpose of finding the gimbal's axes and center of rotation.

As shown in FIG. 7, when a single pusher is provided for an axis and the outer stiffener is not utilized, the resulting axes of rotation are not orthogonal, and the center of rotation is not centered on the flexure. These conditions are caused by the position of the adjustments on the back side of the flexure and their relative location to each of the four beams that make up the flexure. By pushing at a point near the flexure's side, a combination of moments and bending forces are produced in each flexure beam. This action results in a coupled deflection pattern, such that the portion closest to the adjustor (also referred to as beam elements) closest to the adjusters deflect more than the one farthest from the adjuster. Ideally, orthogonal adjustment axes are desired to provide simpler adjustment by the user or system, and in many cases a center of rotation that is centered about the optic is preferred.

As a result of this analysis, the embodiment of FIG. 8 is provided. After the ANSYS modeling results and prototype testing in the laboratory, it was determined that for some applications the slit diaphragm flexure's degree of adjustment coupling was too high to satisfy the requirements of the unit. In order to improve this parameter a flexure stiffener was designed to regulate the bending of the flexure in only in specific regions near where a conventional pivot point would be located. Stiffening the flexure provided fixed areas where bending could occur and, therefore, better-defined rotational axes.

FIG. 8 illustrates an exemplary flexure performance improved by a stiffening element including a center of rotation calculation based on finite element analysis. The embodiment of FIG. 8 is generally similar to the embodiment shown in FIG. 7, with the addition of the stiffener (not shown). Elements which are the same as the elements identified in FIG. 7 are labeled with identical reference numbers. The stiffener is not shown because the purpose of FIGS. 7 and 8 is to discuss the improvement of the center of rotation gained by the stiffener in relation to The stiffener as described above in connection with FIGS. 3 and 4 is one example embodiment of a stiffener although other configurations of stiffeners may be utilized.

In the stiffened version of the flexure, the adjustment axes are closer to perpendicular, and the gimbal's center of rotation is closer to the center of the gimbal. Consequently, by limiting the area in which the flexure can deform, a deformation pattern approximating a conventionally supported gimbal can be achieved. Stated another way, by limiting the area in which the flexure can deform movement of the X axis adjustor moves the flexure along only the X axis, with some degree of variance. By limiting the area in which the flexure can deform movement of the Y axis adjustor moves the flexure along only the Y axis, with some degree of variance.

Ideally, a flexure that is only able to deform in an infinitely small area around the four quadrants of the flexure's perimeter will provide two perfectly perpendicular axes with a perfectly centered center of rotation. In reality the beams in the flexure require some length to provide deflection, and this length prevents a perfect result. Although not perfect, the stiffened version of the flexure as shown herein is able to provide a relatively large amount of deflection in a tight space and simple alignment in an area with limited access, which is an improvement over the non-stiffened version.

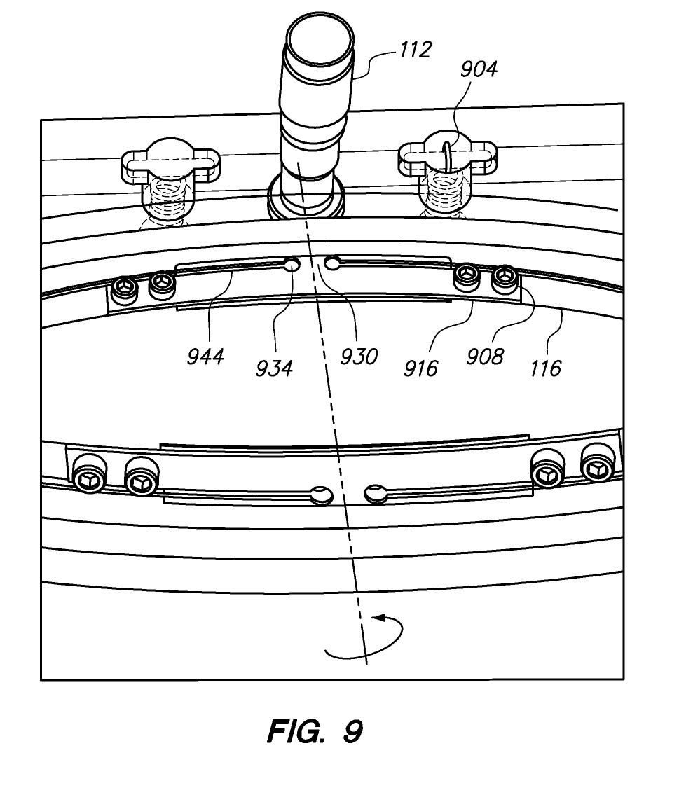

FIG. 9 illustrates an exemplary embodiment of the flexure showing relieved sections 934 near a flexure bridge 930. FIG. 9 shows but one possible embodiment and it is contemplated that the relieved section 934 may be located at different locations and configured with a different shape. As shown, the flexure system includes adjustors 112, as describe above, which provides a force on the flexure 116 against a bias provided by the one or more springs 904. A stiffener 916 is connected to the flexure 116 with mounting bolts 908 as shown. Although shown with bolts it is contemplated that any other connector may be used including screws rivets, welds, glue or other adhesive, clamps, or any other connector. The stiffener 916 may also be integral with the flexure 116, such as if the stiffener is constructed of the same piece of material as the flexure. In this embodiment, the stiffener 916 limits motion to two orthogonal rotational axes.

Also shown in greater detail in FIG. 9 is a bridge 930 (shown as element 740 in FIG. 7) between the inner and outer portions of the flexure 116. The bridge 930 is between the circular slits 944 (shown as element 744 in FIG. 7). At the end of one or more slits 944 is a relieved portion 934 which is generally wider than the slit 944. As shown, the stiffener 916 is also relieved, in the area of the relieve portion 934, or at or near the bridge so that rotation of the flexure is a combination of twisting and bending. The relieved portion 934 provides additional flexibility to the flexure to maintain orthogonal movement and reduce stresses and strain on the flexure.

In the example embodiment of FIG. 9, the relieved portions 934 are shown as circular in shape and located at the end of the slits 944 on each end of the bridge 930. In other embodiments, the relieved portions 934 the may be any shape such as but not limited to oval, triangular, square, or rectangular. In addition, the relieved portion 934 may be located at other locations on the flexure or on only one side of the bridge.

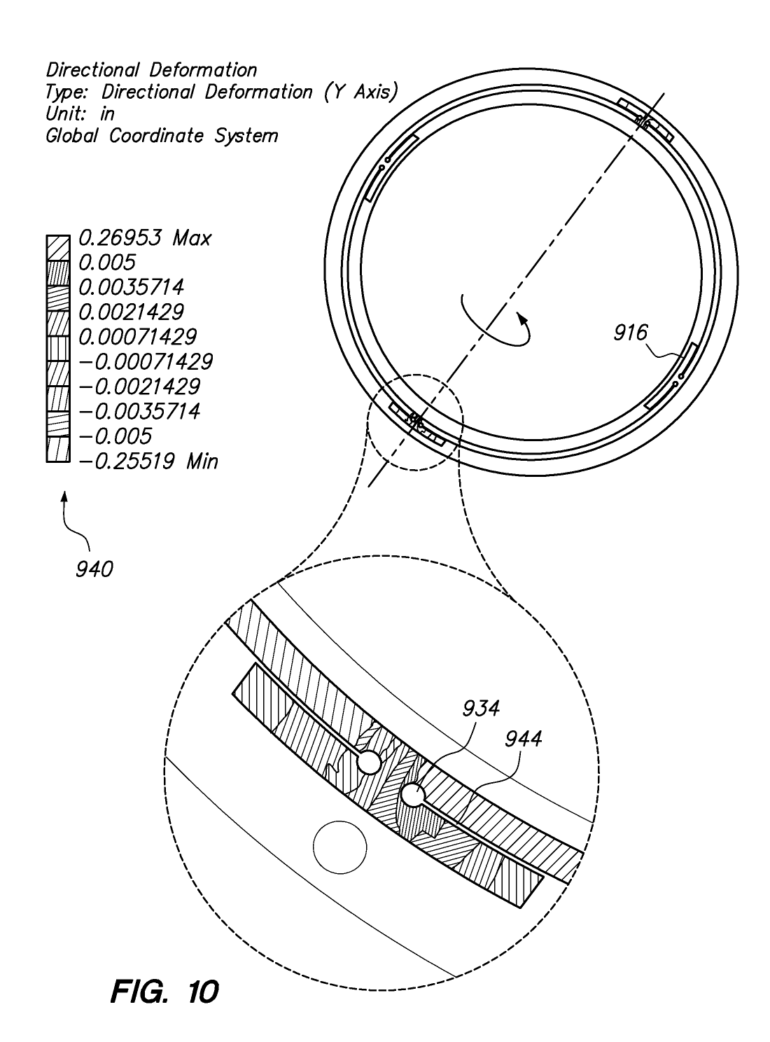

FIG. 10 illustrates an exemplary flexure under flexing rotational force with an enlarged view of the bridge showing numeric flex values. The numeric values shown in FIG. 10 are associated with the example embodiment of FIG. 10. As shown, the stiffeners 916 provide additional support. In enlarged section, the relieved portion 934 located at the end of the slit 944 is provide for reference. Based on the relative motion key 940 shown at the upper left-hand corner of FIG. 10, the movement and strain at the bridge is shown resulting from the rational movement of the flexure.

An analysis of directional deformation confirms that the axis of rotation is highly orthogonal. In this example embodiment the direction of rotation is in and out of the plane defined by the page of FIG. 10. In this configuration, the total deflection is about +/−0.25 inches but between the two inner most bands on each side of the center point the deflection is only about +/−0.005 includes. Upon close inspection of the relative movement at the bridge, the deformation pattern indicates both twisting near the bridge and bending in the relieved portion.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A gimbal comprising:
a base having a bottom and an support structure extending up from the bottom;
two or more mounts connected to the base;
a stiffener connected to two or more mounts;
a slit diaphragm flexure connected to the stiffener around at least an outer to circumference of the slit diaphragm flexure;
one or more adjustors configured to contact the slit diaphragm flexure and move the slit diaphragm flexure in response to movement of the adjustor.

2. The gimbal of claim 1 wherein the stiffener comprises a first ring and a second ring which are releasable secured together by two or more fasteners.

3. The gimbal of claim 2 wherein the slit diaphragm flexure connects to the stiffener by being secured between the first ring and the second ring.

4. The gimbal of claim 1 wherein the gimbal has at least one adjustor associated with each axis of motion.

5. The gimbal of claim 1 wherein the slit diaphragm flexure comprises a sheet of metal having one or more slits around an outer circumference and one or more bridges between the slits.

6. The gimbal of claim 1 wherein the slit diaphragm flexure comprises a sheet of titanium having one or more generally open slits and one or more bridges.

7. The gimbal of claim 1 wherein the bottom of the base is configured with one or more connection points to connect the base to a table or other support surface.

8. The gimbal of claim 1 further comprising a minor connected to an outer surface of slit diaphragm flexure.

9. A flexure and stiffening element system for use in a gimbal comprising:
a generally planar sheet of metal, the sheet having:
an outer edge section;
a middle section; and
an intermediate region between the outer edge section and the middle section, the intermediate region having one or more slits and one or more bridges, and a relieved area between an end of one or more slits and at least one of the bridges to relieve stress on the flexure.

10. The system of claim 9 wherein each of the one or more slits comprises a narrow opening in the sheet running generally parallel with the outer edge.

11. The system of claim 9 wherein one or more bridges comprise a solid section of sheet between the one or more slits that connects the middle section to the outer edge section.

12. The system of claim 9 wherein the stiffening element has a shape that matches the outer edge section.

13. The system of claim 12 wherein the stiffening element comprises a first element and a second element configured to releasably connect to thereby secure the outer edge section between the first element and a second element such that both the first element and the second element have a shape that matches the outer edge section.

14. A movable minor support comprising:
a base having a bottom section and a top section;
a stiffening element configured to hold a sheet flexure;
a mount configured to connect the stiffening element to the base;
a sheet flexure held by the stiffening element, the sheet flexure formed from a flexible sheet of material contained primarily within the stiffening element and configured as having a:
an outer section held by the stiffening element;
an inner section configured to connect to and support the mirror;
a flexure section between the outer section and the inner section, the flexure section comprising two or more slits and two or more bridges;
one or more adjustors configured to move relative to the base to thereby contact the inner section to move inner section relative to the base.

15. The minor support of claim 14 wherein the top section is angled to present the minor at an angled position.

16. The minor support of claim 14 wherein the two or more slits comprise openings cut from the sheet flexure and the two or more bridges comprise sections of sheet between the openings which connect the outer section to the inner section.

17. The minor support of claim 14 wherein the stiffening element comprises at least one rigid structure having a shape that generally matches the outer section of the sheet flexure but not extending into the inner section of the sheet flexure.

18. The minor support of claim 14 wherein moving the inner section relative to the base comprises moving the angle of the inner section.

19. The minor support of claim 14 wherein the flexures comprise threaded screw adjustors which move upward or downward when rotated.

20. The minor support of claim 14 further comprising a minor connected to the inner section of the sheet flexure.

21. The minor support of claim 14 wherein the flexure section further includes a relieved section located along one of the two or more slits.
